(19) United States
(12) Patent Application Publication
(10) Pub. No.: US 2003/0160964 A1
(43) Pub. Date: Aug. 28, 2003

(54) System and method for measuring position of optical transmission members in an array

(76) Inventors: Joseph L. Dallas, Maple Glen, PA (US); Angelique X. Irvin, Radnor, PA (US); Robert W. Irvin, Radnor, PA (US); Ralph S. Jameson, Orefield, PA (US); William A. Mamakos, Laurel, MD (US)

Correspondence Address: CANTOR COLBURN, LLP, 55 GRIFFIN ROAD SOUTH, BLOOMFIELD, CT, 06002

(21) Appl. No.: 10/084,894

(22) Filed: Feb. 27, 2002

(51) Int. Cl. G01B 9/02

(52) U.S. Cl. 356/496

(57) ABSTRACT

A method and system for measuring the position of optical transmission members in an array includes: directing a laser light from a single laser source to two or more optical transmission members in an array; creating an optical interference pattern between the laser light emanating from the two or more optical transmission members; and characterizing the optical interference pattern to provide information about a position of the two or more optical transmission members in the array. In one embodiment, the array is a one-dimensional array. In another embodiment, the array is a two-dimensional array.

### BACKGROUND

The present invention relates to optical transmission members. More specifically, the present invention relates to a system and method for measuring the position of optical transmission members in an array.

Optical transmission members, such as optical fibers, waveguides, and the like, may be arranged to form an optical transmission array. The optical transmission array may include two or more optical transmission members fixed to a substrate by use of an adhesive material. Precise alignment of each optical transmission member relative to the substrate and to other optical transmission members in the array is an important factor affecting the efficiency of light transmission between the optical transmission members of the array and an optical device or optical transmission member to which the array is coupled. To ensure the proper positioning of the optical transmission members in the array, it is often necessary to measure the position of each optical transmission member relative to various reference points. The method used to measure position must have both high resolution and high accuracy. To be effective, the measurement method must have substantially greater resolution than the allowed position error. Typically, the required resolution is 0.1 micron or better.

Various methods have been developed to measure the position of optical transmission members. One example is provided in U.S. Pat. No. 5,946,099 to Ota et al., entitled “Method of Measuring Positions of Optical Transmission Members”. U.S. Pat. No. 5,946,099 describes a lens system forming a beam arranged to oppose an end face of an optical transmission member in the array. The beam is input to the optical transmission member, and the lens system is translated relative to the optical transmission member until the intensity of a light beam emanating from the optical transmission member is at its maximum. Thereafter, a position of the transmission member is determined from the position of the lens system.

Like other methods developed to measure the position of optical transmission members, the method provided in U.S. Pat. No. 5,946,099 requires the physical movement of two or more mechanical parts (e.g., the lens system). This may require a high degree of precision and frequent calibration of the movable, mechanical parts. Thus, there remains a need for precisely measuring the position of optical transmission members.

### BRIEF SUMMARY

In one aspect of the present invention, there is provided a method for measuring the position of optical transmission members in an array, the method comprising: directing a laser light from a single laser source to two or more optical transmission members in an array; creating an optical interference pattern between the laser light emanating from the two or more optical transmission members; and characterizing the optical interference pattern to provide information about a position of the two or more optical transmission members in the array. In one embodiment, the array is a one-dimensional array. In another embodiment, the array is a two-dimensional array.

In another aspect of the present invention, a system for measuring optical transmission member position in an array comprises: a laser source configured to provide laser light to two or more optical transmission members in the array; a target plane arranged to receive the laser light emanating from the two or more optical transmission members; and wherein the laser light emanating from the two or more optical transmission members forms an interference pattern on the target plane, the interference pattern including a characteristic indicating a position of the two or more optical transmission members. In one embodiment, the array is a one-dimensional array. In another embodiment, the array is a two-dimensional array.

### BRIEF DESCRIPTION OF THE DRAWINGS

This disclosure will present in detail the following description of preferred embodiments with reference to the exemplary drawings wherein like elements are numbered alike in the several FIGURES:

FIG. 1 is a plan view of a system for measuring position of optical transmission members in an array;

FIG. 2 is an elevation view of the system of FIG. 1;

FIG. 3 is a perspective view of an example of a one-dimensional array of optical transmission members;

FIG. 4 is an example of an optical interference pattern;

FIG. 5 is another example of an optical interference pattern;

FIG. 6 is a flow chart depicting a method for measuring position of optical transmission members in a one-dimensional array;

FIG. 7 is an example of a two-dimensional array of optical transmission members;

FIG. 8 is another example of a two-dimensional array of optical transmission members; and

FIGS. 9A and 9B are flow charts depicting a method for measuring position of optical transmission members in a two-dimensional array.

### DETAILED DESCRIPTION OF THE PREFERRED EMBODIMENTS

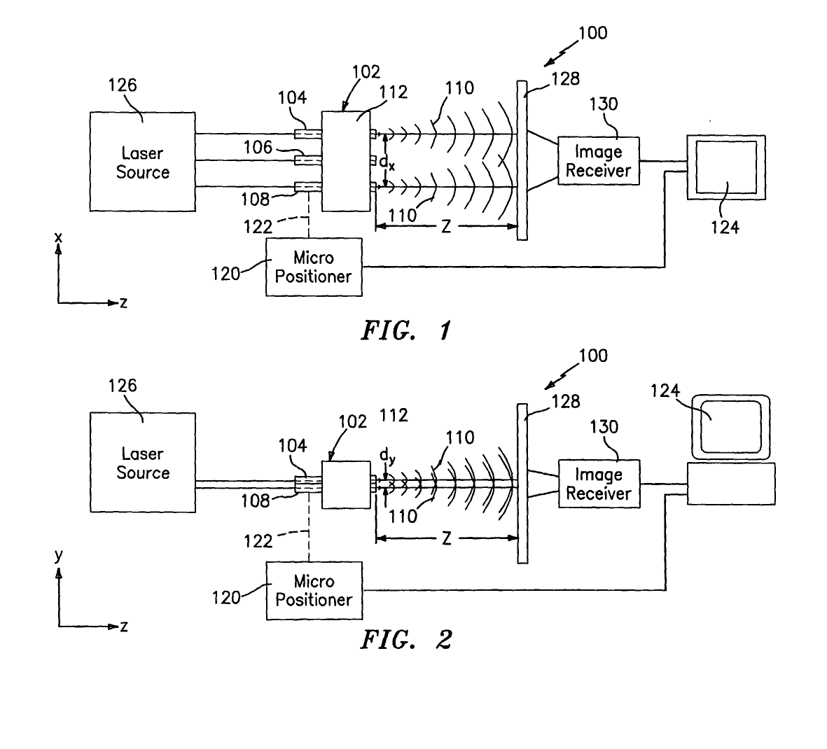

Some embodiments of the invention will now be described in detail in the following Examples. Referring to FIGS. 1 and 2, a system 100 for measuring optical transmission member position in an array 102 is shown. FIG. 1 is a plan view of system 100 in the x-z plane, and FIG. 2 is an elevation view of system 100 in the y-z plane. System 100 measures the positions of optical transmission members 104, 106 and 108 in array 102 by creating an optical interference pattern between laser light 110 simultaneously emanating from two or more optical transmission members. The interference pattern is then characterized to provide sensitive information about the position of each optical transmission members 104, 106, and 108. Using this interferometric measurement, the positions of optical transmission members 104, 106, and 108 in an assembled array 102 may be checked for accuracy. In addition, this interferometric measurement may be used in the active positioning of optical transmission members 104, 106, and 108 during the array 102 assembly process. As used herein, an optical transmission member is any device that transmits light, and may include, for example, optical fibers, optical waveguides, or the like. An array is an arrangement of optical transmission members. Array 102 may be constructed by adhering the optical transmission members 104, 106, and 108 to a structure, such as an array substrate, as is known in the art.

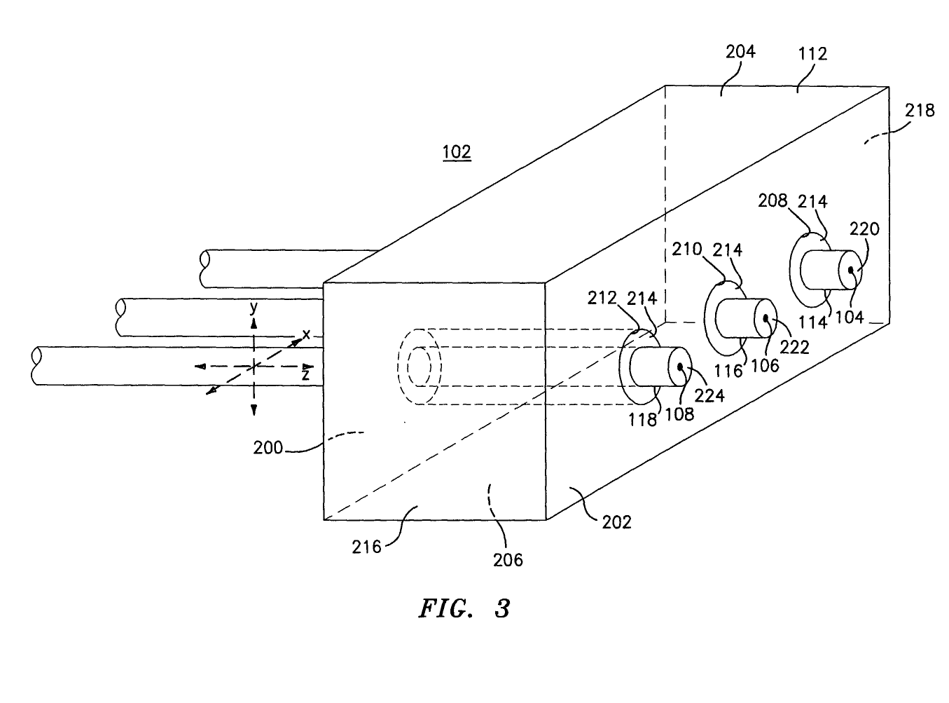

Referring to FIG. 3, a perspective view illustrating an exemplary array 102 is shown wherein optical transmission members 104, 106, and 107 comprise optical fibers 114, 116, and 118. In the embodiment shown in FIG. 2, array member 112 is a structure having opposing end surfaces 200 and 202, a top surface 204, a bottom surface 206, and opposing side surfaces 216 and 218. In the array 102, array member 112 is provided to arrange and fix multiple optical fibers 114, 116, and 118 therein. Multiple optical fibers 114, 116, and 118 terminate at end surfaces 220, 222, and 224, respectively. The array member 112 has through-holes 208, 210, and 212 each extending through the array member 112 from end surface 200 to end surface 202 in a direction corresponding to a longitudinal direction of the optical fibers 114, 116, and 118, respectively. The through-holes 208, 210, and 212 are filled with adhesive material 214, preferably a UV-cure adhesive, which is cured by being exposed to UV (ultraviolet) light. Each of the optical fibers 114, 116, and 118 is coated, preferably airtightly, with the adhesive 214 in corresponding one of the through-holes 208, 210, and 212.

In the embodiment shown, the optical fibers 114, 116, and 118 are movable in the respective through-holes 208, 210, and 212, unless the UV-cure adhesive 214 is cured by exposure to UV light. Before the UV-cure adhesive 214 is fully cured, the optical fibers 114, 116, and 118 may be readily adjusted to desired positions so that the optical fibers 114, 116, and 118, respectively are aligned to desired horizontal (x), vertical (y), and longitudinal (z) positions. Once in their desired positions, the optical fibers 114, 116, and 118 are then fixed relative to the array member 112 by curing the UV-cure adhesive 214. Thus, active adjustment or repositioning of each optical fiber 114, 116, and 118 may be performed.

Referring to FIGS. 1-3, adjustment of the optical fibers 114, 116, and 118 in the array member 112 is performed by an adjusting mechanism (e.g., a micro positioner) 120, which may be employed at either or both ends 200 and 202 of the fiber array member 112. The adjusting mechanism 120 preferably has multiple manipulators 122 for adjusting positions of the optical fibers 114, 116, and 118 in response to control signals received from a computer or controller 124. Each manipulator 122 is associated with corresponding one of the optical fibers 114, 116, and 118 to precisely control the position of each optical fiber 114, 116, and 118. Computer 124 controls adjusting mechanism 120 using feedback measurements provided by system 100, which measures the positions of the cores of the optical fibers 114, 116, and 118 in array 102 by creating an optical interference pattern between laser light 110 simultaneously emanating from two or more of the optical fibers 114, 116, and 118.

System 100 includes a laser source 126 (e.g., a 6328 Angstrom, Helium-Neon laser) optically coupled to two or more of the optical fibers 114, 116, and 118. Laser source 126 is a single laser that is split to provide light to each of the two or more fibers being measured. Light from laser source 126 emanates from end surfaces 220, 222, and 224 of the illuminated fibers 114, 116, and 118, each of which are separated by a distance Z in the longitudinal “z” direction from a target plane 128. Target plane 128 may include, for example, a screen, a lens, or a light-receiving element as may be found in a digital video camera. Laser light 110 emanating from end surfaces 220, 222, and/or 224 creates an optical interference pattern at the target plane 128. An image receiver 130 (e.g., a digital video camera) may be arranged proximate to target plane 128 to convert the light received at target plane 128 into digital signals indicating the optical interference pattern. The digital signals from image receiver 130 are provided to computer 124, which characterizes the interference pattern to determine sensitive information about the position of each illuminated fiber.

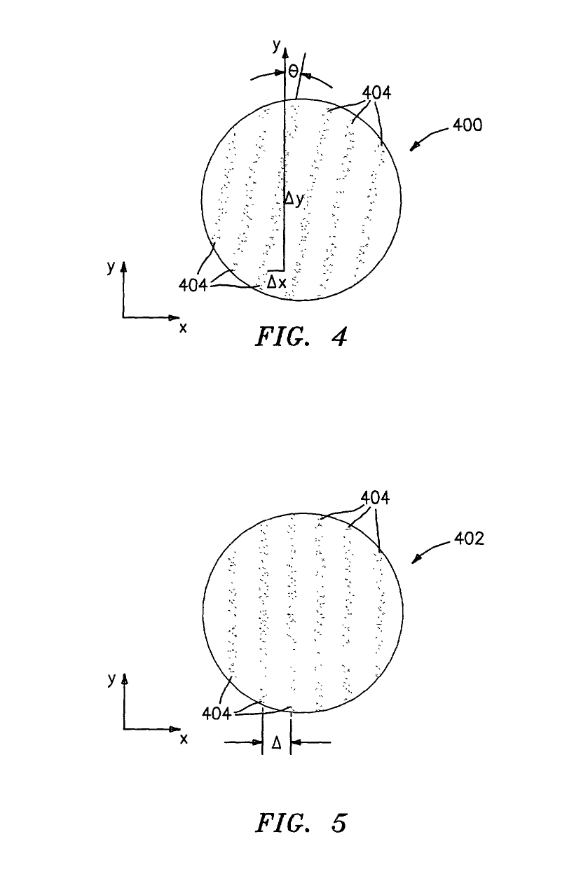

Referring to FIGS. 4 and 5, two examples of interference patterns are shown at 400 and 402, respectively. As can be seen in FIGS. 4 and 5, the interference patterns 400 and 402 each include a series of generally parallel interference fringes 404 separated by a distance Δ, which is indicated in FIG. 5. The interference fringes 404 of FIG. 5 are oriented along the vertical axis y, and the interference fringes 402 of FIG. 4 are oriented at an angle θ from the vertical axis y. Using characteristics of the interference pattern, such as the separation distance Δ and orientation angle θ, computer 124 can determine sensitive information about the position of each illuminated optical transmission member 104, 106, 108. For example, the separation distance Δ of the interference fringes may be represented by the equation:

Δ=Zλ/dₓ (1)

where: “Z” is the distance from the transmission member end faces 220, 222, and 224 to the target plane 128; “λ” is the wavelength of the light used in laser source 126; and “dₓ” is the separation distance in the x direction between the centers of the illuminated optical transmission members. Using equation (1), the separation distance “dₓ” between the illuminated optical transmission members may be calculated from the separation distance Δ of the interference fringes and the known distance Z. In another example, the angle θ is proportional to the vertical offset of the illuminated optical transmission members relative to the orientation of the horizontal x axis of the measurement system 100 (indicated as “d_{y}” in FIG. 2). Accordingly, the angle θ may be used to determine the vertical offset “d_{y}” of the illuminated optical transmission members. In another example, the interference fringes may be resolved into horizontal (Δₓ) and vertical (Δ_{y}) components, as indicated in FIG. 4, to reveal the horizontal (“dₓ”) and vertical (“d_{y}”) components of the optical transmission member separation.

Preferably, characterization of the interference pattern is performed by computer 124, where computer 124 receives digital information indicating the interference pattern from image receiver 130. In response to the data collected from characterization of the interference pattern (e.g., the horizontal position “dₓ” and the vertical offset “d_{y}”), computer 124 can control adjusting mechanism 120 to position the appropriate optical transmission member. Once in their desired positions, the optical transmission members (e.g., optical fibers 114, 116, and 118) are then fixed relative to the array member 111 by curing the adhesive 214.

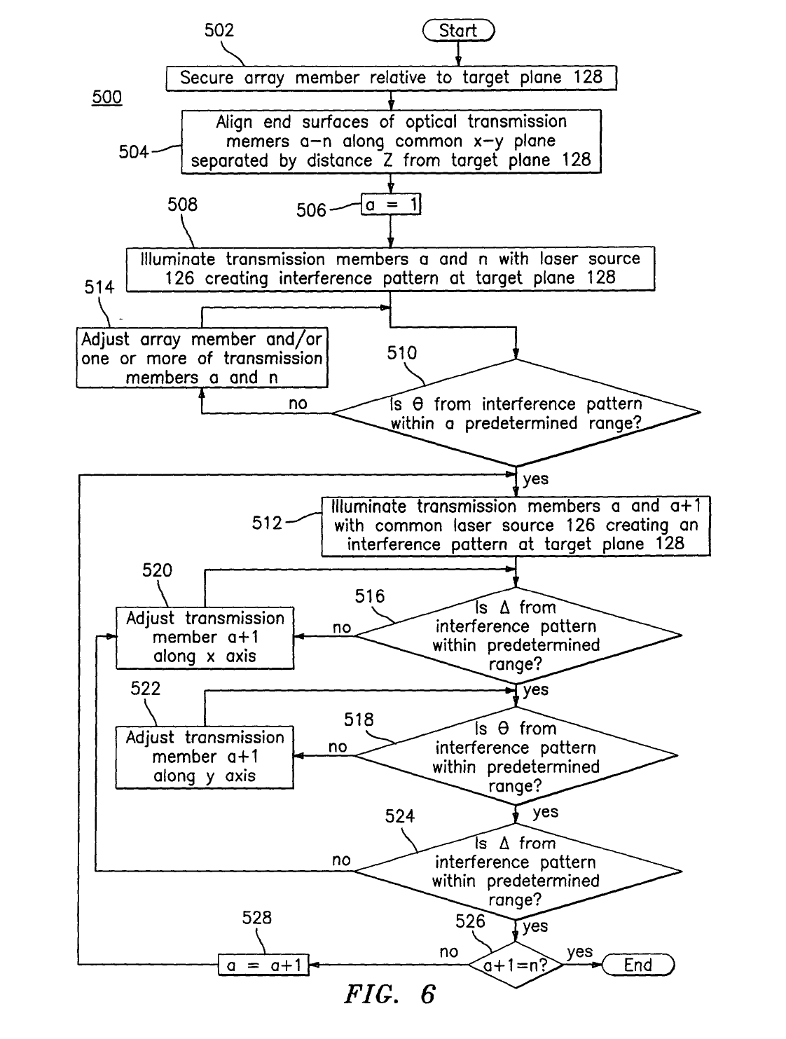

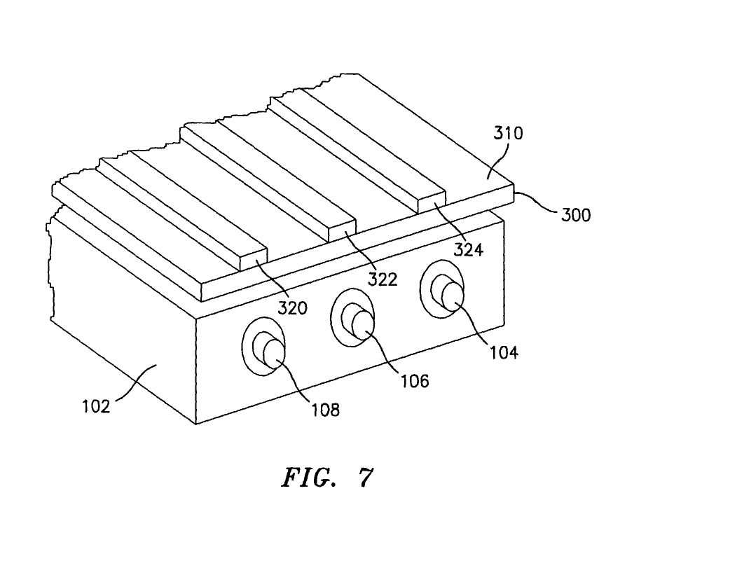

FIG. 6 is a flow chart depicting a method 500 of measuring optical transmission member position in array 102 that may be employed by system 100. FIG. 6 is applicable to any array having two or more optical transmission members (indicated in FIG. 6 as optical transmission members 1 through n). Method 500 will now be described by way of example, using the array 102 provided in FIGS. 1 through 3.

Method 500 begins at step 502 where the array member 112 is secured relative to target plane 128. This step may be accomplished using a fixture that supports both the array member 112 and target plane 128. Method 500 continues at step 504, where the end surfaces 220, 222, and 224 of fibers 114, 116, and, 118, respectively, are aligned within predetermined tolerances along a common x-y plane, which is parallel to target plane 128 and separated therefrom by the predetermined distance Z. Method 500 continues to steps 506 and 508 where the first and last fibers in the array (fibers 114 and 118 as shown in FIG. 1) are illuminated by common laser source 126 so that the light emanating from the two fibers forms an interference pattern at target plane 128.

Method 500 continues to step 508 where the orientation angle θ of the interference fringes is compared to a predetermined range. If the orientation angle is within the predetermined range, indicating that the center of the first and last fibers are aligned with the horizontal x axis of the measurement system 100, method continues to step 512. However, if the orientation angle is not within the predetermined range, fiber array member 112 and/or one of the illuminated fibers is (are) adjusted in step 514. In this manner, the horizontal axis of the fiber array 102 is established. Steps 510 and 514 are repeated until the orientation angle θ is within the predetermined range of step 510.

In step 512, the first and second fibers (fibers 114 and 116 as shown in FIG. 1) are illuminated using common laser source 126 so that the light from the two illuminated fibers forms an interference pattern at target plane 128. As previously noted, the separation “dₓ” between the illuminated fiber cores is a function of the separation Δ of the interference fringes in the interference pattern. If, in step 516, the separation Δ of the interference fringes is within a predetermined range, indicating that the separation “dₓ” between the illuminated fibers 114 and 116 is within an acceptable range, method continues to step 518. However, if the separation Δ in step 516 is not within the predetermined range, computer 124 instructs adjusting mechanism 120 to adjust fiber 116 along the x axis in step 520. Steps 516 and 520 are repeated until Δ is within the predetermined range in step 516.

In step 518, the orientation angle θ of the interference fringes is checked against a predetermined range. As previously noted, the orientation angle θ of the interference fringes is proportional to the vertical offset “d_{y}” of the illuminated fibers. Accordingly, the value of θ in the interference pattern created by light emanating from the first and second fibers indicates the vertical offset “d_{y}” of the second fiber. Thus, to ensure that the vertical offset “d_{y}” is within an acceptable range, the value of θ from the interference pattern is checked against a predetermined range. If, in step 518, θ is within the predetermined range, method 500 continues to step 524. However, if θ is not within the predetermined range, computer 124 instructs adjusting mechanism 120 to adjust the vertical offset “d_{y}” of fiber 116 in step 522. Steps 516 and 522 are repeated until θ is within the predetermined range in step 516.

It will be recognized that adjustment of the vertical offset “d_{y}” in step 522 may affect the separation “dₓ” of the illuminated fiber cores. Therefore, in step 524, separation Δ of the interference fringes is again compared with the predetermined range of step 516 to ensure that the separation “dₓ” between the illuminated fibers 114 and 116 is within an acceptable range. If the separation Δ in step 524 is not within the predetermined range, method 500 returns to step 520 where computer 124 instructs adjusting mechanism 120 to adjust fiber 116 along the x axis. If the separation Δ in step 524 is within the predetermined range, alignment of the second fiber 116 is complete, and method 500 continues to step 526.

In step 526, it is determined whether the last fiber aligned is the last fiber in the array. If the last fiber has been aligned (i.e., fiber “a+1” is fiber “n”), then method 500 ends. If the last fiber has not yet been aligned, method continues to step 528 where the next fiber to be aligned is selected, and method continues at step 512. Method 500 ends when the last fiber has been adjusted.

System 100 precisely measures the positions of the cores of fibers 114, 116, and 118 in array 102 by creating an optical interference pattern between laser light 110 simultaneously emanating from two or more fiber cores. The interference pattern is characterized to provide sensitive information about the position of each fiber core without requiring the physical measurement of distance between two or more movable parts. In addition, this interferometric measurement may be used in the active positioning of fibers 114, 116, and 118 during the array 102 assembly process.

Referring to FIG. 7, a perspective view of two arrays mounted proximate each other is shown. In this embodiment, an array comprising a planar waveguide device 300 is mounted in proximity to multi-fiber array 102 to form a two-dimensional optical array 800. Waveguide device 300 is mounted in such a way that the end faces 320, 322, 324 of optical transmission members mounted thereon (shown here as waveguides) are approximately in a same plane as the optical fiber endfaces 220, 222, and 224. It will be recognized that the system for measuring optical fiber arrays, 100, and the method 500 may substitute the two-dimensional optical array 800 for the multi-fiber array 102 shown in FIG. 3. Laser light 110 emanating from two or more of waveguide endfaces 320, 322 or 324, and from two or more optical fiber endfaces 220, 222, and 224 combine to form an optical inference pattern, which may be characterized to provide sensitive information about the relative positions of the optical transmission members in the two arrays.

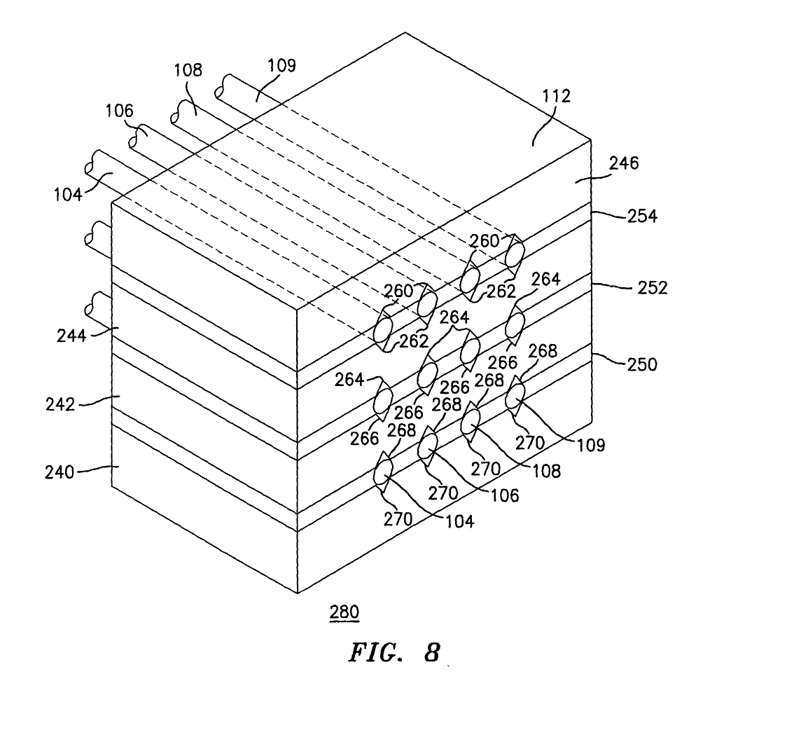

FIG. 8 presents a perspective view of an exemplary two dimensional array 280 comprising rows of optical transmission members 104, 106, 108, and 109, which are shown here as optical fibers. In the embodiment shown, the two dimensional array 280 is composed of a baseplate 240, intermediate plates 242 and 244, and a cover plate 246. The cover plate 246 contains several grooves 260 into which one row of optical transmission members 104, 106, 108, and 109 (shown here as optical fibers) are disposed. Intermediate plate 244 has corresponding several grooves 262 in the upper surface which mate with grooves 260 of the cover plate 246. The top row of optical transmission members 104, 106, 108, and 109 are thus held in a fixed position by the corresponding sets of grooves. Adhesive layer 254 fixes the top row of optical transmission members 104, 106, 108, and 109 in position, and fixes cover plate 246 in relation to intermediate plate 244. Intermediate plate 244 has also grooves 264 in the lower surface into which a middle row of optical transmission members 104, 106, 108, and 109 are similarly disposed. Intermediate plate 242 similarly contains grooves 266 in an upper surface for mating with grooves 264, and grooves 268 in a lower surface for disposing the bottom row of optical transmission members 104, 106, 108, and 109. Basepate 240 contains corresponding grooves 270 for mating with grooves on the lower surface of intermediate plate 242. Adhesive layers 252 and 250 fix optical transmission members 104, 106, 108, and 109 in the middle and bottom rows, respectively, in place.

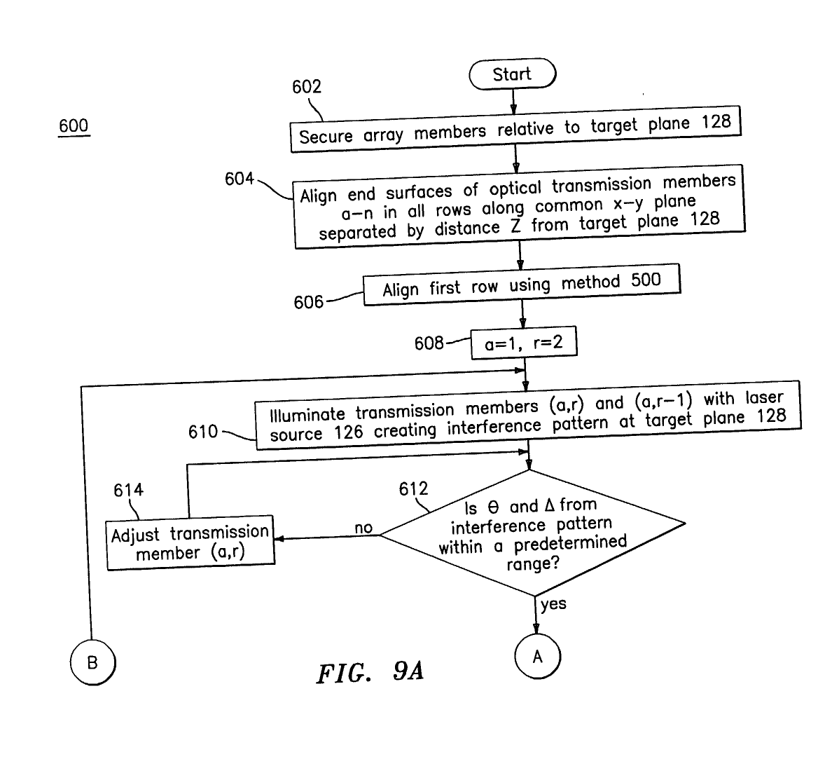

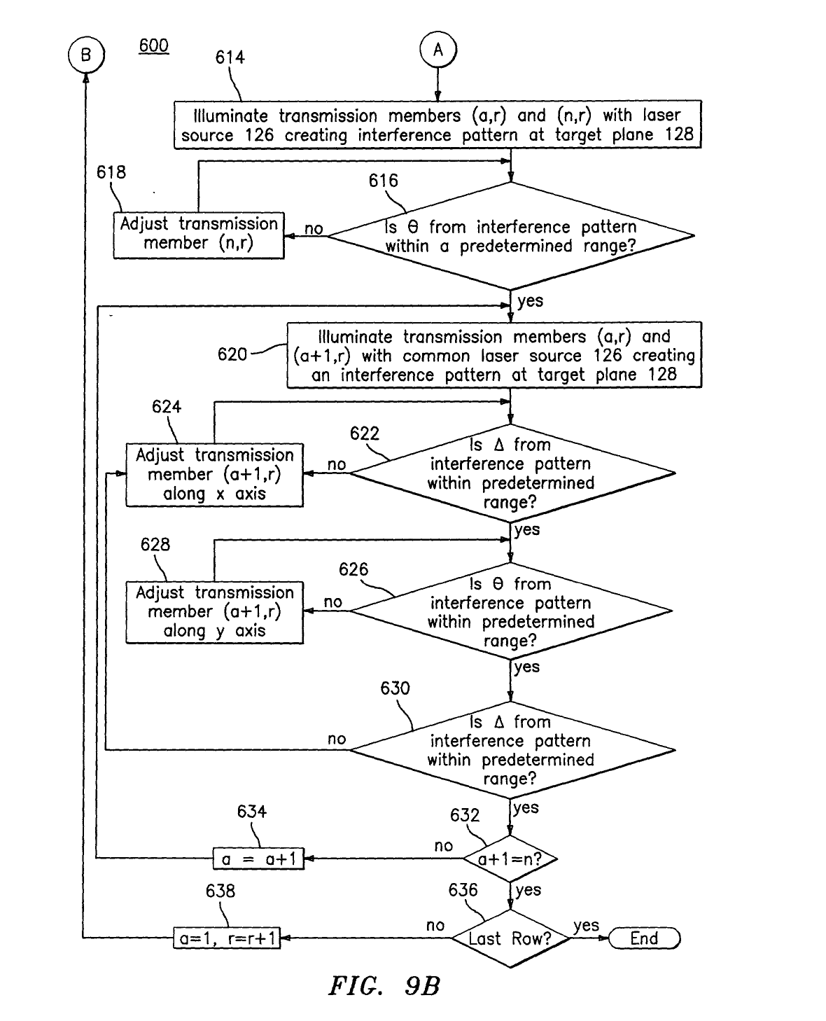

Referring to FIG. 9, a flow chart depicts a method 600 that may be employed by system 100 (FIG. 1) for measuring optical transmission member position in a two dimensional array having “r” rows, with each row having optical transmission members “a” through “n”. Method 600 may be employed in any two dimensional array of optical transmission members, but will be described herein with reference to the two dimensional array 280 shown in FIG. 8. Method 600 begins at step 602 where the array members 240, 242, 244, and 246 are secured relative to target plane 128. This step may be accomplished using a fixture that supports the array members 240, 242, 244, and 246 and target plane 128. Method 500 continues at step 604, where end surfaces of transmission members 104, 106, 108, and 109 in each row, respectively, are aligned within predetermined tolerances along a common x-y plane, which is parallel to target plane 128 and separated therefrom by the predetermined distance Z. Method 600 continues to step 606 where the first row (e.g., the bottom row) of array members 240, 242, 244, and 246 are aligned using method 500, described with reference to FIG. 6. After the first row has been aligned, method 600 continues to steps 608 and 610 where the first transmission member of the second row (transmission member (a, r)) and the first transmission member of the first row (transmission member (a, r−1)) are illuminated by common laser source 126 so that the light emanating from the two transmission members forms an interference pattern at target plane 128. In step 612, the orientation angle θ and separation Δ of the interference fringes are compared to predetermined ranges. If the orientation angle is within the predetermined range, indicating that the first transmission member of the second row is positioned correctly, method 600 continues to step 614. However, if the orientation angle θ or separation Δ are not within predetermined ranges, method 600 continues to step 618 where the first transmission member of the second row is adjusted, and the orientation angle θ and separation Δ are again checked at step 612.

After the first transmission member of the second row (transmission member (a, r)) and the first transmission member of the first row (transmission member (a, r−1)) have been aligned, method 600 continues to step 614 where the first and last transmission members in the second row of the array (transmission members (a, r), and (n, r)) are illuminated by common laser source 126 so that the light emanating from the two fibers forms an interference pattern at target plane 128.

Method 600 continues to step 616 where the orientation angle θ of the interference fringes is compared to a predetermined range. If the orientation angle is within the predetermined range, indicating that the center of the first and last transmission members in the second row are aligned with the horizontal x axis of the measurement system 100, method 600 continues to step 620. However, if the orientation angle is not within the predetermined range, the last transmission member (transmission member (n, r)) is adjusted in step 618. In this manner, the horizontal axis of the second row of the fiber array is established. Steps 616 and 618 are repeated until the orientation angle θ is within the predetermined range of step 616.

In step 620, the first and second transmission members in the second row (transmission members (a, r) and (a+1, r)) are illuminated using common laser source 126 so that the light from the two illuminated transmission members forms an interference pattern at target plane 128. As previously noted, the separation “dₓ” between the illuminated transmission members is a function of the separation Δ of the interference fringes in the interference pattern. If, in step 622, the separation Δ of the interference fringes is within a predetermined range, indicating that the separation “dₓ” between the illuminated transmission members is within an acceptable range, method 600 continues to step 626. However, if the separation Δ in step 622 is not within the predetermined range, computer 124 instructs adjusting mechanism 120 to adjust transmission member (a+1, r) along the x axis in step 624. Steps 622 and 624 are repeated until Δ is within the predetermined range in step 622.

In step 626, the orientation angle θ of the interference fringes is checked against a predetermined range. As previously noted, the orientation angle θ of the interference fringes is proportional to the vertical offset “d_{y}” of the illuminated transmission members. Accordingly, the value of θ in the interference pattern created by light emanating from transmission members (a, r) and (a+1, r) indicates the vertical offset “d_{y}” of the transmission member (a+1, r). Thus, to ensure that the vertical offset “d_{y}” is within an acceptable range, the value of θ from the interference pattern is checked against a predetermined range. If, in step 626, θ is within the predetermined range, method 600 continues to step 630. However, if θ is not within the predetermined range, computer 124 instructs adjusting mechanism 120 to adjust the vertical offset “d_{y}” of transmission member (a+1, r) in step 628. Steps 626 and 628 are repeated until θ is within the predetermined range in step 626.

It will be recognized that adjustment of the vertical offset “d_{y}” in step 628 may affect the separation “dₓ” of the illuminated transmission devices. Therefore, in step 630, separation Δ of the interference fringes is again compared with the predetermined range of step 622 to ensure that the separation “dₓ” between the illuminated transmission members (a+1, r) is within an acceptable range. If the separation Δ in step 630 is not within the predetermined range, method 600 returns to step 620 where computer 124 instructs adjusting mechanism 120 to adjust transmission member (a+1, r) along the x axis. If the separation Δ in step 630 is within the predetermined range, alignment of the second transmission member in the second row is complete, and method 600 continues to step 632.

In step 632, it is determined whether the last transmission member aligned is the last transmission member in the array. If the last transmission member has been aligned (i.e., transmission member (a+1, r) is fiber (n, r)), then method 600 continues to step 636. If the last transmission member of the row has not yet been aligned, method 600 continues to step 634 where the next transmission member to be aligned is selected, and method 600 continues at step 620. If, in step 632, the last transmission member of the row has been aligned, method 600 continues to step 638, where it is determined if the current row is the last row. If the current row is not the last row, then method 600 continues to step 638 where the next row to be aligned is selected. If the current row is the last row, then all of the transmission members have been aligned, and method 600 ends.

Method 600 allows the location of transmission members in a two-dimensional array to be accurately measured by creating an optical interference pattern between laser light 110 simultaneously emanating from two or more transmission members. The interference pattern is characterized to provide sensitive information about the position of each transmission member without requiring the physical measurement of distance between two or more movable parts. In addition, this interferometric measurement may be used in the active positioning of the transmission members during the array assembly process.

Having described preferred embodiments of a system and method for measurement of fiber position in an optical fiber array, modifications and variations can be readily made by those skilled in the art in light of the above teachings. It is therefore to be understood that, within the scope of the appended claims, the present invention can be practiced in a manner other than as specifically described herein.

What is claimed is:

1. A method for measuring optical transmission member position in an array, the method comprising:
directing a laser light from a single laser source to two or more optical transmission members in an array;
creating an optical interference pattern between the laser light emanating from the two or more optical transmission members; and
characterizing the optical interference pattern to provide information about a position of the two or more optical transmission members in the array.

2. The method of claim 1, wherein the characterizing includes:
comparing a separation distance between interference fringes in the optical interference pattern to one or more predetermined values.

3. The method of claim 1, wherein the characterizing includes:
calculating a separation distance dₓ between the two or more optical transmission members by applying the equation:
Δ=Zλ/dₓ
where Δ is a separation distance between interference fringes in the optical interference pattern, and λ is the wavelength of the laser light used.

4. The method of claim 1, wherein the characterizing includes:
resolving interference fringes in the optical interference pattern into horizontal and vertical components.

5. The method of claim 1, wherein the characterizing includes: comparing an orientation of interference fringes in the optical interference pattern with a known axis.

6. The method of claim 1, further comprising:
capturing the optical interference pattern with a digital video camera; and
generating a digital representation of the captured optical interference pattern.

7. The method of claim 1, further comprising:
actively aligning at least one of the two or more optical transmission members in response to the information about the position of the two or more optical transmission members.

8. The method of claim 1, wherein the array is a one-dimensional array.

9. The method of claim 1, wherein the array is a two-dimensional array.

10. The method of claim 9, wherein the two-dimensional array comprises:
an optical fiber array; and
an optical waveguide array proximate said optical fiber array.

11. The method of claim 1, wherein the two or more optical transmission members include at least one optical fiber.

12. The method of claim 1, wherein the two or more optical transmission members include at least one waveguide,.

13. A method for measuring optical transmission member position in an array, the method comprising:
illuminating a first optical transmission member in the array and a second optical transmission member in the array with a laser;
creating an optical interference pattern between laser light emanating from the first optical transmission member and the second optical transmission member; and
characterizing the optical interference pattern to provide a position of the second optical transmission member relative to the first optical transmission member.

14. The method of claim 13, wherein the characterizing the optical interference pattern includes:
comparing a separation distance between interference fringes in the optical interference pattern to one or more predetermined values.

15. The method of claim 14, further comprising:
adjusting one or more of the first optical transmission member and the second optical transmission member in response to the comparing the separation distance between interference fringes.

16. The method of claim 14, further comprising:
comparing an orientation of the interference fringes in the optical interference pattern with a known axis.

17. The method of claim 16, further comprising:
adjusting one or more of the first optical transmission member and the second optical transmission member in response to the comparing the orientation of the interference fringes.

18. The method of claim 13, wherein the array is a two-dimensional array.

19. The method of claim 18, wherein the two-dimensional array comprises:
an optical fiber array; and
an optical waveguide array proximate said optical fiber array.

20. The method of claim 18, wherein the first optical transmission member and the second optical transmission member are in different rows in the array.

21. The method of claim 13, wherein the array is a one-dimensional array.

22. The method of claim 13, wherein at least one of the first and second optical transmission members is an optical fiber.

23. The method of claim 13, wherein at least one of the first and second optical transmission members is a waveguide.

24. A system for measuring optical transmission member position in an array, the system comprising:
a laser source configured to provide laser light to two or more optical transmission members in the array;
a target plane arranged to receive the laser light emanating from the two or more optical transmission members; and
wherein the laser light emanating from the two or more optical transmission members forms an interference pattern on the target plane, the interference pattern including a characteristic indicating a position of the two or more optical transmission members.

25. The system of claim 24, further including:
an image receiver configured to convert light received at the target plane into digital signals indicating the optical interference pattern; and
a computer operably coupled to the image receiver, the computer determining the position of the two or more optical transmission members.

26. The system of claim 25, wherein at least one of the optical transmission members is actively aligned in response to the position of the two or more optical transmission members determined by the computer.

27. The system of claim 24, wherein the array is a two-dimensional array.

28. The system of claim 27, wherein the two-dimensional array comprises:
an optical fiber array; and
an optical waveguide array proximate said optical fiber array.

29. The system of claim 24, wherein the first optical transmission member and the second optical transmission member are in different rows in the array.

30. The system of claim 24, wherein the array is a one-dimensional array.

31. The system of claim 24, wherein the two or more optical transmission members include at least one optical fiber.

32. The system of claim 24, wherein the two or more optical transmission members include at least one waveguide.
